(19) United States
(12) Patent Application Publication
(10) Pub. No.: US 2024/0344544 A1
(43) Pub. Date: Oct. 17, 2024

(54) Fastener

(71) Applicant: Illinois Tool Works Inc., Glenview, IL (US)

(72) Inventors: Zhilin LI, Shanghai (CN); Jiahui HE, Shanghai (CN)

(21) Appl. No.: 18/629,848

(22) Filed: Apr. 8, 2024

(30) Foreign Application Priority Data
Apr. 13, 2023 (CN) 202310395491.3

(51) Int. Cl. F16B 21/07; F16B 5/06

(52) U.S. Cl. CPC F16B 21/075; F16B 5/0621

(57) ABSTRACT

The present disclosure provides a fastener, comprising a main body and a retaining member. The main body comprises a supporting beam. The retaining member is connected with the supporting beam and comprises a pair of retaining arms on a first side and a second side of the supporting beam respectively. The pair of retaining arms are configured to be deflectable toward the supporting beam to enable the retaining member to be inserted into a hole of a mounting part. The pair of retaining arms are configured to abut against the hole to retain the fastener in the hole. The main body is made of a first material, and the retaining member is made of a second material that is more wear-resistant than the first material. The retaining member in the present disclosure can be detached and installed multiple times.

### RELATED APPLICATION

The present application claims the benefit of Chinese Patent Application No. 202310395491.3, filed Apr. 13, 2023, titled “Fastener,” the contents of which are hereby incorporated by reference.

### BACKGROUND

The present disclosure relates to a fastener, and in particular to a fastener which is used for connecting two panels. Fasteners can be used for connecting multiple components together, for example, connecting interior trim parts, frames, panels and so on of a vehicle. For connection, a first component is connected to a fastener, and then the fastener with the first component connected thereto is mounted at a corresponding position on a second component such that the first component and the second component are connected to each other. For example, in one application, a vehicle door panel needs to be connected to a vehicle body metal plate by means of the fastener such that the vehicle door panel is securely connected to the vehicle body metal plate.

### SUMMARY OF THE DISCLOSURE

The present disclosure relates generally to a fastener, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastener according to the present disclosure.

FIG. 1B is a perspective view of the fastener in FIG. 1A from another perspective.

FIG. 1C is an exploded view of the fastener in FIG. 1A.

FIG. 2A is a perspective view of a main body in FIG. 1C.

FIG. 2B is a cross-sectional view of the main body in FIG. 1C taken in a height direction and a width direction of the fastener.

FIG. 2C is a top view of the main body in FIG. 2A.

FIG. 2D is a cross-sectional view of the main body in FIG. 2A taken in the width direction and a length direction.

FIG. 3A is a perspective view of a retaining member in FIG. 1C.

FIG. 3B is a perspective view of the retaining member in FIG. 3A from another perspective.

FIG. 3C is a side view of the retaining member in FIG. 3A.

FIG. 4 is a cross-sectional view of the fastener in FIG. 1C.

FIG. 5A is an exploded view of the fastener in FIG. 1A, a first component and a second component.

FIG. 5B is a perspective view illustrating the connection between the fastener in FIG. 1A, the first component and the second component.

FIG. 5C is a cross-sectional view illustrating the connection between the fastener in FIG. 5B, the first component and the second component.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it should be understood that although the terms such as “front”, “rear”, “upper”, “lower”, “left”, and “right” indicating directions are used in the present disclosure to describe various exemplary structural parts and elements of the present disclosure, these terms used herein are merely used for ease of description and are determined based on the exemplary orientation shown in the accompanying drawings. Since the embodiments disclosed in the present disclosure can be arranged in different directions, these terms indicating directions are only illustrative and should not be considered as limitations.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastener, including: a main body and a retaining member. The main body comprises a supporting beam. The retaining member is connected with the supporting beam and comprises a pair of retaining arms on a first side and a second side of the supporting beam respectively. The pair of retaining arms are configured to be deflectable toward the supporting beam to enable the retaining member to be inserted into a hole of a mounting part. The pair of retaining arms are configured to abut against the hole to retain the fastener in the hole. The main body is made of a first material, and the retaining member is made of a second material that is more wear-resistant than the first material.

In the fastener as mentioned above, the first material is a thermoplastic material, and the second material is a metal material.

In the fastener as mentioned above, the retaining member is detachably mounted on the main body.

In the fastener as mentioned above, each of the pair of retaining arms includes an upper portion and a lower portion connected to each other, lower portions of the pair of retaining arms are connected to each other and extend in a direction away from each other, and upper portions of the pair of retaining arms extend in a direction toward each other. Outer surfaces of the upper portions form contact portions abutting against the hole.

In the fastener as mentioned above, the retaining member includes at least one pair of deflectable connecting legs. The at least one pair of connecting legs are provided between the pair of retaining arms and connected to the pair of retaining arms respectively. The at least one pair of connecting legs extend at an angle relative to the supporting beam and are configured to resiliently clamp the supporting beam therebetween to connect the retaining member with the supporting beam.

In the fastener as mentioned above, the supporting beam includes a pair of ribs. The at least one pair of deflectable connecting legs cooperate with the pair of ribs to prevent the movement of the retaining member with respect to the supporting beam in a direction from the upper portion to the lower portion of each of the pair of retaining arms.

In the fastener as mentioned above, the at least one pair of deflectable connecting legs include a pair of first connecting legs and a pair of second connecting legs. The pair of first connecting legs are connected to upper ends of the corresponding pair of the retaining arms, respectively, and extend obliquely toward each other in a direction toward lower ends of the pair of retaining arms. The pair of second connecting legs are connected to the lower ends of the corresponding pair of retaining arms, respectively, and extend obliquely toward each other in a direction toward the upper ends of the pair of retaining arms. The pair of first connecting legs comprise abutting portions capable of contacting the supporting beam, the pair of second connecting legs comprise abutting portions capable of contacting the supporting beam, and the abutting portions of the pair of second connecting legs are spaced apart from the abutting portions of the pair of first connecting legs.

In the fastener as mentioned above, the supporting beam has a third side and a fourth side opposite to each other, the third side and the fourth side are on two ends of the first side and the second side, respectively, and have flanges extending beyond outer surfaces of the first side and the second side. The flanges are configured to limit the retaining member therebetween.

In the fastener as mentioned above, the main body further includes a base. The base includes a head, a neck and a body. The neck is provided between the head and the body, the size of the neck is smaller than the size of the head and the size of the body, and the neck is movable into a groove of a component to be connected.

In the fastener as mentioned above, the neck is provided with an outer contour having an anti-rotation shape, such that when the neck enters into the groove of the component to be connected, the neck prevents the rotation of the fastener with respect to the component to be connected.

In the fastener as mentioned above, the outer contour of the neck is of an obround shape.

In the fastener as mentioned above, the fastener is configured to be mounted on the mounting part with a square hole.

The fastener of the present disclosure comprises the main body and the retaining member, where the retaining member is capable of contacting a mounting part. The retaining member is made of a wear-resistant material, so that the fastener can be plugged and unplugged multiple times and is not easily damaged.

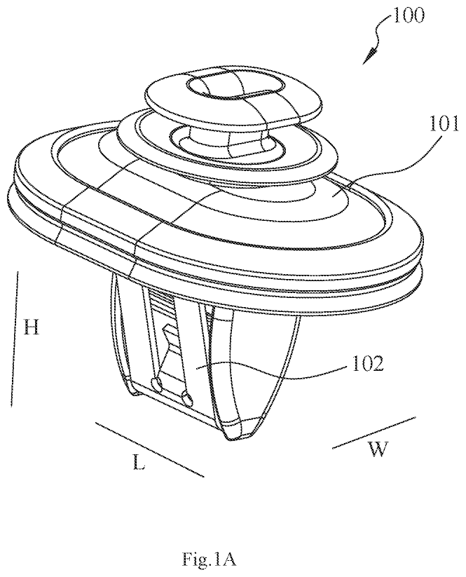

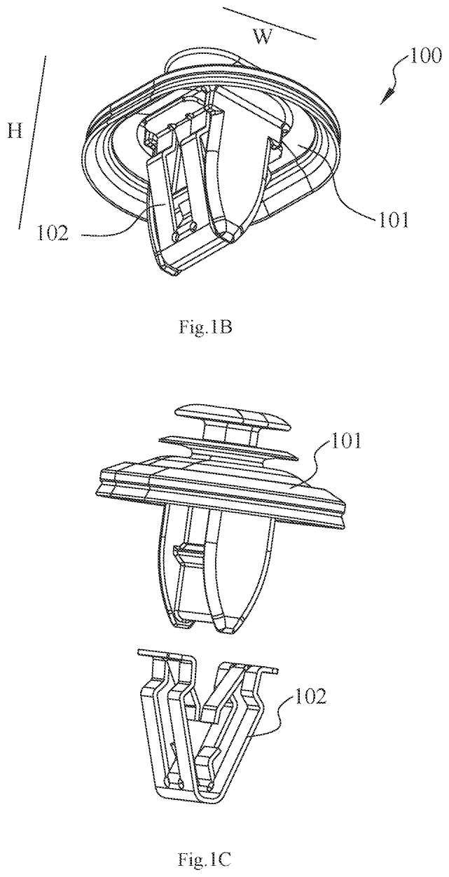

FIG. 1A is a perspective view of a fastener according to the present disclosure, FIG. 1B is a perspective view of the fastener in FIG. 1A from another perspective, and FIG. 1C is an exploded view of the fastener in FIG. 1A. FIGS. 1A-1C show the structure and components of the fastener.

As shown in FIGS. 1A-1C, the fastener 100 includes a main body 101 and a retaining member 102, and the retaining member 102 is detachably sleeved on the main body 101. The fastener 100 can be connected with a first component, and can be inserted into a mounting hole of a second component, so that the first component is connected to the second component. The retaining member 102 is made of a material that is more wear-resistant than the material of the main body 101. In an embodiment of the present disclosure, the main body 101 is made of a thermoplastic material, and the retaining member 102 is made of a metal material. The fastener 100 has a length direction L, a height direction H and a width direction W.

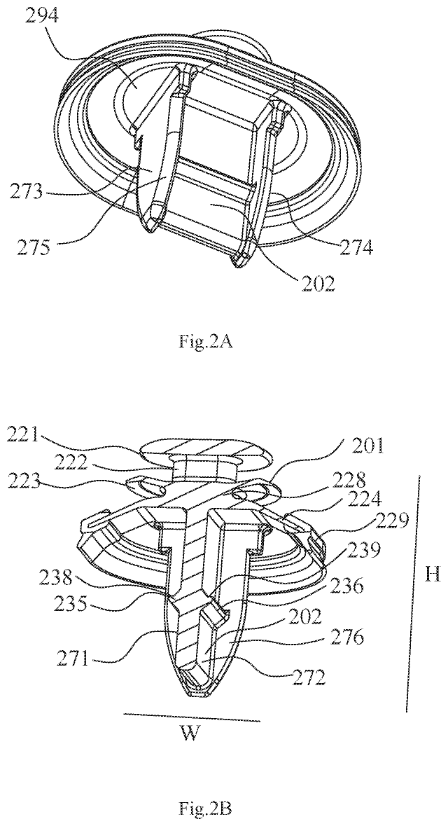

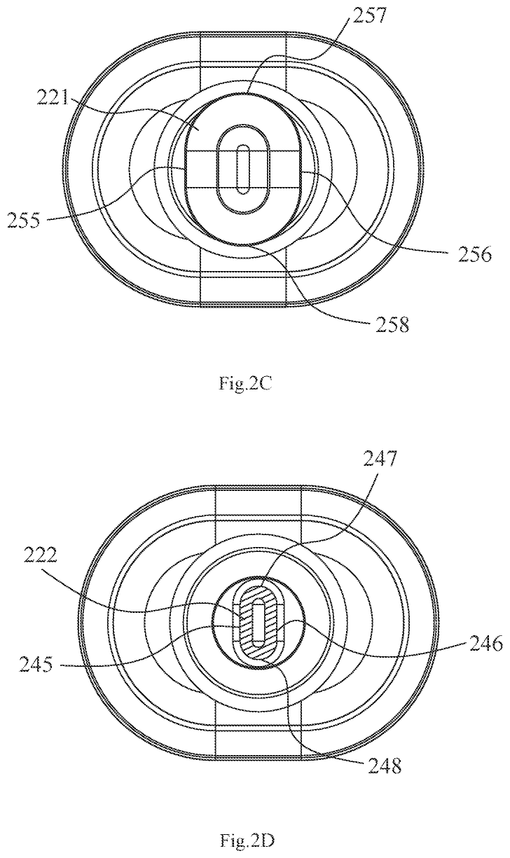

FIG. 2A is a perspective view of the main body 101 in FIG. 1C, FIG. 2B is a cross-sectional view of the main body 101 in FIG. 1C taken in the height direction and the width direction of the fastener 100, FIG. 2C is a top view of the main body in FIG. 2A, and FIG. 2D is a cross-sectional view of the main body in FIG. 2A taken in the width direction and the length direction. FIG. 2A and FIG. 2B show the structure of the main body 101 of the fastener.

As shown in FIG. 2A to FIG. 2D, the main body 101 includes a base 201 and a supporting beam 202, and the supporting beam 202 is connected to the base 201. The base 201 includes a head 221, a neck 222, a body 223 and a skirt 224. The neck 222 is between the head 221 and the body 223, and the size of the neck 222 is smaller than the size of the head 221 and the size of the body 223, so that the neck 222 is the thinnest part of the base 201.

In an embodiment of the present disclosure, viewing from the height direction, the body 223 is substantially circular, and both the neck 222 and the head 221 are obround. For example, having the form of a flattened cylinder with the sides parallel and the ends hemispherical. That is, the cross section of the body 223 is substantially circular, and the cross section of the neck 222 and the cross section of the head 221 are substantially obround. The neck 222 has a pair of straight edges 245 and 246 and a pair of arc edges 247 and 248, and the straight edges 245 and 246 are parallel to each other. The straight edge 245, the arc edge 247, the straight edge 246 and the arc edge 248 are sequentially connected, so that the cross section of the neck 222 is obround. The head 221 has a pair of straight edges 255 and 256 and a pair of arc edges 257 and 258, the straight edges 255 and 256 being parallel to each other. The straight edge 255, the arc edge 258, the straight edge 256 and the arc edge 258 are sequentially connected, so that the cross section of the head 221 is obround. The neck 222 and the head 221 are non-cylindrical. The extending directions of the pair of straight edges 245 and 246 of the neck 222 are the same as the extending directions of the pair of straight edges 255 and 256 of the head 221. The head 221 is shaped to indicate an insertion direction of the fastener, and the neck 222 is shaped to prevent the rotation of the fastener with respect to a component to be connected.

The skirt 224 is connected to the body 223 through a connecting portion 228, and two ends of the connecting portion 228 are respectively connected to respective centers of the body 223 and the skirt 224. The skirt 224 extends obliquely from the connecting portion 228 toward a direction away from the body 224 and beyond the body 223. The main body 101 further has a scaling lip 229, the sealing lip 229 is provided at a distal end of the skirt 224 and covering an edge of the distal end of the skirt 224. The sealing lip 229 is made of an elastic material, and is configured to seal between the fastener and a mounting part. The scaling lip 229 is connected to the skirt 224 through an overmolding process.

In an embodiment of the present disclosure, the main body 101 includes a body 223 and a skirt 224. In another embodiment of the present disclosure, the main body 101 includes only a skirt 224, the neck 222 being arranged between the head 221 and the skirt 224.

The supporting beam 202 of the main body 101 extends from a lower surface 294 of the skirt 224 toward a direction away from the head 221. The supporting beam 202 has a first side 271 and a second side 272 opposite to each other, and a third side 273 and a fourth side 274 opposite to each other. The first side 271 and the second side 272 extend in the height direction H and the length direction L of the fastener 100, so that the supporting beam 202 is generally plate-shaped. The first side 271 and the second side 272 of the supporting beam 202 are respectively provided with ribs 235 and 236 in the length direction L of the fastener 100. The ribs 235 and 236 respectively protrude from an outer surface of the first side 271 and the second side 272. Two ends of the ribs 235 and 236 respectively extend to the third side 273 and the fourth side 274. The ribs 235 and 236 are provided with limiting surfaces 238 and 239 on a side facing the base 201, respectively. The ribs 235 and 236 are configured to cooperate with the retaining member 102, so as to limit the movement of the retaining member 102 with respect to the main body 101 in the height direction H of the fastener 100. The third side 273 and the fourth side 274 of the supporting beam 202 have flanges 275 and 276 extending in the height direction H and the width direction W of the fastener 100, the flanges 275 and 276 both extend beyond the surfaces of the first side 271 and the second side 272. The flanges 275 and 276 are configured to cooperate with the retaining member 102, so as to limit the movement of the retaining member 102 with respect to the main body 101 in the length direction L of the fastener 100.

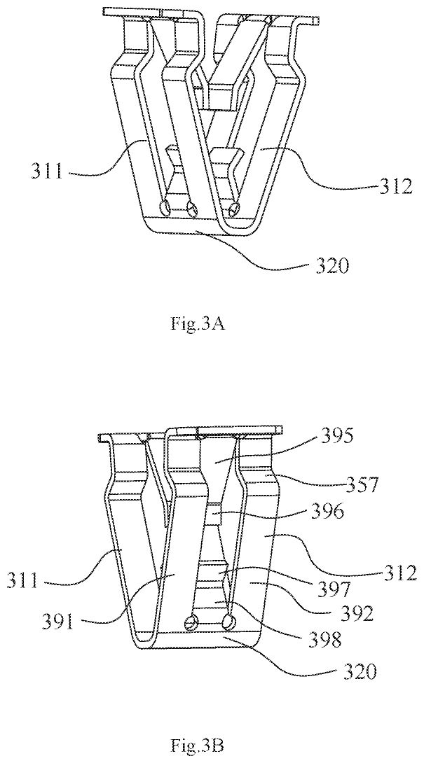

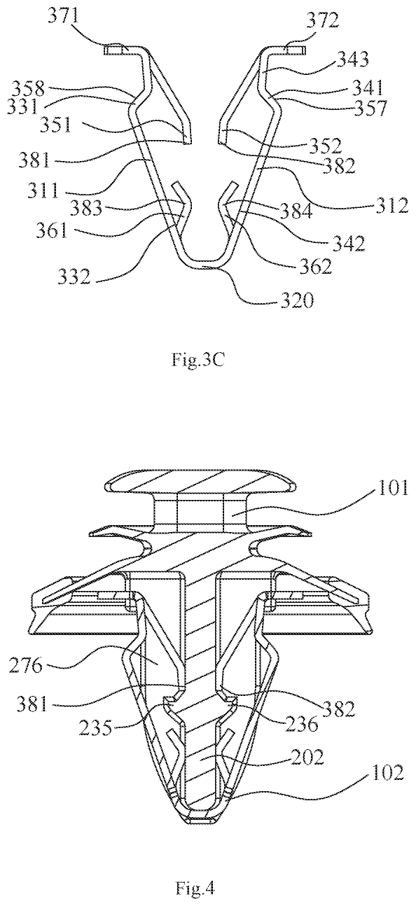

FIG. 3A is a perspective view of the retaining member in FIG. 1C, FIG. 3B is a perspective view of the retaining member in FIG. 3A from another perspective, and FIG. 3C is a side view of the retaining member in FIG. 3A. As shown in FIGS. 3A-3C, the retaining member 102 includes an end portion 320, a pair of retaining arms 311 and 312, a pair of first connecting legs 351 and 352, a pair of second connecting legs 361 and 362, and a pair of tail portions 371 and 372.

As shown in FIG. 3C, viewing in the length direction of the fastener 100, the end portion 320 is a roughly curved arch. Two sides of the end portion 320 are respectively connected to the pair of retaining arms 311 and 312. The retaining arms 311 and 312 are respectively connected to the tail portions 371 and 372. The retaining arms 311 and 312 are symmetrically arranged, the tail portions 371 and 372 are symmetrically arranged, the first connecting legs 351 and 352 are symmetrically arranged, and the second connecting legs 361 and 362 are symmetrically arranged. The structure of the retaining arm is introduced below with the retaining arm 312, the tail portion 372, the first connecting leg 352 and the second connecting leg 362 as examples.

The retaining arm 312 includes an upper portion 341, a lower portion 342 and an extension portion 343. The lower portion 342 is connected at one end thereof to the end portion 320 and extends obliquely toward a direction away from the retaining arm 311, and the upper portion 341 is connected to the lower portion 342 and extends toward a direction close to the retaining arm 311. The junction of the upper portion 341 and the lower portion 342 forms a bending part, that is, the retaining arm 312 is bent outward near the junction of the upper portion 341 and the lower portion 342. The outer surface of the upper portion 341 forms a contact portion 357. The contact portion 357 is capable of contacting an edge of a hole in a mounting component. In an embodiment of the present disclosure, the outer surface of the upper portion 341 is a contact portion 357. In another embodiment of the present disclosure, the contact portion 357 is a part of the outer surface of the upper portion 341. The extension portion 343 extends from the upper portion 341 generally in a vertical direction shown in FIG. 3C, that is, the height direction of the fastener 100. The extension portion 343 is connected at one end thereof to the upper portion 341, and is connected at the other end thereof to the tail portion 372.

The retaining arm 312 further includes a first part 391 and a second part 392, two ends of each of the first part 391 and the second part 392 are respectively connected to the end portion 320 and the tail portion 372, and a distance is provided between the first part 391 and the second part 392, thereby forming a hollow portion 393.

In some embodiments of the present disclosure, the retaining arm 312 includes one part, or three or more parts.

The first connecting leg 352 and the second connecting leg 362 of the retaining member 102 are provided between the first part 391 and the second part 392, that is, the first connecting leg 352 and the second connecting leg 362 are aligned with the hollow portion 393. The first connecting leg 352 and the second connecting leg 362 are elastic, that is, deflectable. The first connecting leg 352 is connected to the tail portion 372, and extends obliquely toward the end portion 320 and the retaining arm 311, and the second connecting leg 362 is connected to the end portion 320, and extends obliquely toward the tail portion 372 and the retaining arm 311. That is, the first connecting leg 352 and the second connecting leg 362 extend toward each other. In an embodiment of the present disclosure, a distance is provided between distal ends of the first connecting leg 352 and the second connecting leg 362. The distal end of the first connecting leg 352 is provided with an abutting portion 382, the abutting portion 382 is capable of abutting against the supporting beam 202 of the main body 101.

In an embodiment of the present disclosure, the first connecting leg 352 includes an upper section 395 and a lower section 396, and relative to the height direction of the fastener 100, an inclination angle of the upper section 395 is greater than that of the lower section 396. In an embodiment of the present disclosure, the second connecting leg 362 includes an upper section 397 and a lower section 398. The upper section 397 and the lower section 398 are connected to form a shape that curves outward, the junction of the upper section 395 and the lower section 396 forms an abutting portion 384, and the abutting portion 384 is capable of abutting against the supporting beam 202.

Similarly, the retaining arm 311 has an upper portion 331 and a lower portion 332, the upper portion 311 has a contact portion 358, the first connecting leg 351 has an abutting portion 381, and the second connecting leg 361 has an abutting portion 383.

A distance is provided between the tail portions 371 and 372 of the retaining member 102, and the supporting beam 202 is capable of being inserted into the retaining member 102 from the distance between the tail portions 371 and 372. The minimum distance between the first connecting legs 351 and 352 and the minimum distance between the second connecting legs 361 and 362 are both smaller than a thickness of the supporting beam 202, so that when the retaining member is sleeved on the main body 101, the first connecting legs 351 and 352 and the second connecting legs 361 and 362 each is deflected at a certain amount to apply an elastic force to the supporting beam 202, such that the retaining member 102 can be clamped onto the main body 101.

In some embodiments, the retaining member may be provided with only a pair of connecting legs that are configured to cooperate with the ribs of the supporting beam to limit the downward movement of the retention member in the height direction H of the fastener relative to the body. To this end, the pair of connecting legs may be connected to other portions of the retaining member at their lower ends and extend upwardly at an angle, or may be connected to other portions of the retaining member at their upper ends and extend downwardly at an angle, as long as the pair of connecting legs are able to cooperate with the ribs of the supporting beam to limit the downward movement of the retention member in the height direction H of the fastener relative to the body.

FIG. 4 is a cross-sectional view of the fastener in FIG. 1C, showing a cooperative relationship of the retaining member and the main body. As shown in FIG. 4, the supporting beam 202 of the main body 101 can be inserted into the retaining member 102 from one side of the tail portions 371 and 372 of the retaining member 102. During the insertion, the first connecting legs 351 and 352 move over the pair of the ribs 235 and 236, and are finally located on the side of the pair of ribs 235 and 236 close to the base 201, and the second connecting legs 361 and 362 are located on the side of the ribs 235 and 236 away from the base 201.

When the retaining member 102 and the main body 101 are connected in place, the first connecting legs 351 and 352 and the second connecting legs 362 and 363 generate a certain deformation, and the abutting portions 381 and 382 of the first connecting legs 351 and 352 and the abutting portions 383 and 384 of the second connecting legs 361 and 362 are each in contact with the supporting beam 202, so as to clamp the retaining member 102 to the supporting beam 202. Since there is a distance between the abutting portions 381 and 382 and between the abutting portions 383 and 384, it can prevent the retaining member 102 from shaking with respect to the main body 101. The distal ends of the first connecting legs 351 and 352 abut against the limiting surfaces 238 and 239 of the ribs 235 and 236, so as to limit the movement of the retaining member with respect to the main body 101 in a direction away from the base 201. The retaining member 102 is located between the flanges 275 and 276, so that the flanges 275 and 276 may limit the movement of the retaining member 102 with respect to the main body 101 in the length direction of the fastener 100.

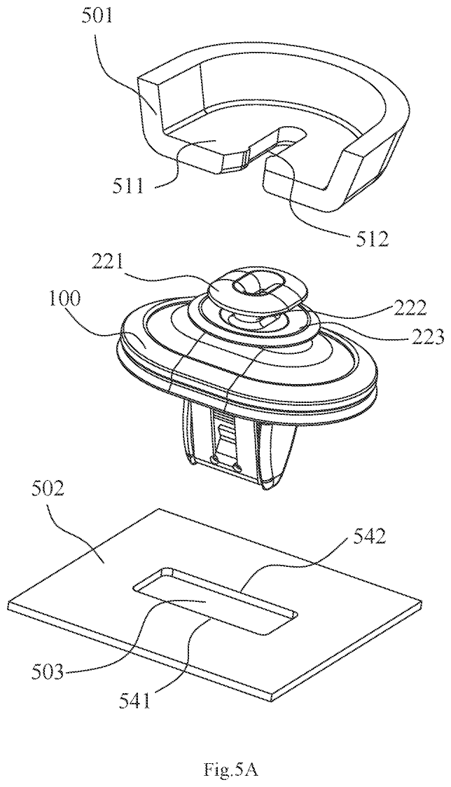

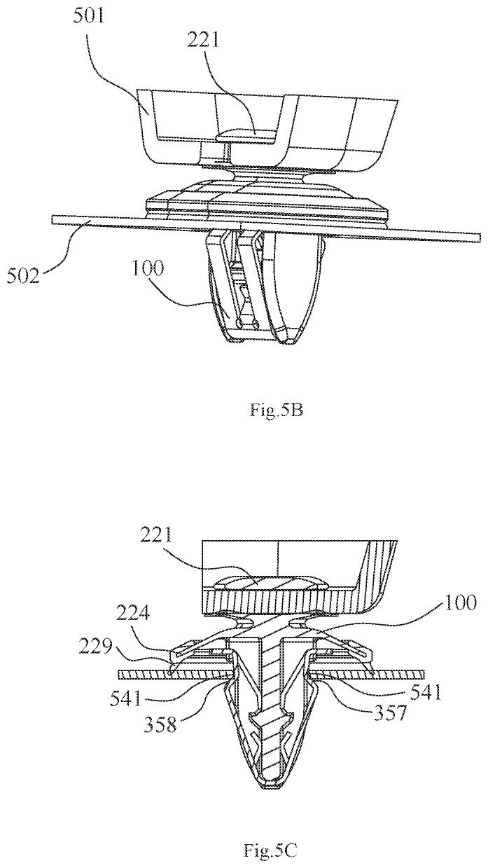

FIG. 5A is an exploded view of the fastener in FIG. 1A, a first component and a second component, FIG. 5B is a perspective view illustrating the connection between the fastener in FIG. 1A, the first component and the second component, and FIG. 5C is a cross-sectional view illustrating the connection between the fastener in FIG. 5B and the first component and the second component. FIGS. 5A-5C show the connection relationship between the fastener and the first component and the second component.

As shown in FIGS. 5A-5C, the first component 501 has a connecting plate 511, the connecting plate 511 is provided with a mounting groove 512, and one end of the mounting groove 512 has an opening 514. The mounting groove 512 is elongated. The second component 502 has a mounting hole 503, the mounting hole 503 being a square hole or an elongated hole. The mounting hole 503 has a pair of length sides 541 and 542. In an embodiment of the present disclosure, the length sides 541 and 542 are parallel to each other. In connecting the first component 501 to the second component 502, the neck 222 of the fastener 100 is firstly inserted into the mounting groove 512 of the first component 501 in the width direction of the fastener 100. The size of the neck 222 of the fastener 100 matches the size of the mounting groove 512, and the fastener 100 may slide in the mounting groove 512 in the width direction (i.e. the extending direction of the mounting groove) but may not rotate with respect to the first component 501. Then the angle of the fastener 100 is adjusted such that the length direction of the fastener 100 is the same as the extending direction of the length sides 541 and 542 of the mounting hole 503, and the fastener 100 connected to the first component 501 is inserted into the mounting hole 503 of the second component 502. In the process of inserting the fastener 100 into the mounting hole 503, respective lower portions 332 and 342 of the retaining arms 311 and 312 abut against inner edges of the length sides 541 and 542, such that the retaining arms 311 and 312 are pressed by the inner edges of the length sides 541 and 542 and deform inward, and respective lower portions 332 and 342 of the retaining arms 311 and 312 may pass through the mounting hole 503. As the distance between respective upper portions 331 and 341 of the retaining arms 311 and 312 tapers in the insertion direction of the fastener 100, when the mounting hole 503 is flush with the upper portions 331 and 332, the retaining arms 311 and 312 restore from deformation in a direction away from each other, so that the distal ends of the respective upper portions of the retaining arms extend beyond the length sides 541 and 542, so as to prevent the fastener 100 from detaching from the second component 502 in a direction opposite the insertion direction. When the fastener 100 is mounted in place in the second component 502, the inner edges of the length sides 541 and 542 abut against the contact portions 358 and 357 of the retaining arms 311 and 312. The sealing lip 229 at the distal end of the skirt 224 abuts against the upper surface of the second component 502. The second component 502 is clamped between the contact portions 358 and 357 of the retaining arms 311 and 312 and the sealing lip 229 at the distal end of the skirt 224, so that the fastener 100 may not move with respect to the second component 502 in the height direction. The first component 501 is then connected to the second component 502 through the fastener 100.

In this embodiment, the fastener 100 may slide with respect to the mounting hole 503 in the length direction, but may not rotate with respect to the second component 502. In an application, the position of the fastener 100 with respect to the mounting hole 503 and the position of the fastener 100 with respect to the mounting groove 512 both can be adjusted, so as to adapt to assembly tolerances of the first component 501 and the second component 502.

In the present disclosure, the first component 501 is a component to be connected, and the second component 502 is a mounting part. In an application of the present disclosure, the first component 501 is a vehicle door panel, and the second component 502 is a vehicle body metal plate. The first component 501 is made of a thermoplastic material, and the second component 502 is made of metal. When it is necessary to detach the first component 501 from the second component 502, the fastener 100 is pulled out of the mounting hole of the second component 502 opposite the insertion direction of the fastener 100. The retaining arms 311 and 312 are pressed by the length sides 541 and 542 of the mounting hole 503 to deform inward, so that the junction of the upper portion and the lower portion of each of the retaining arms 311 and 312 may pass through the mounting hole 503, and the fastener 100 is detached from the second component 502. In the process of pulling out the fastener 100, friction occurs between the inner edge of the mounting hole 503 of the second component 502 and the contact portions 358 and 357 of the retaining arms 311 and 312. In the present disclosure, the contact portions 358 and 357 of the retaining arms 311 and 312 are made of a metal material, and are less prone to wear in the process of pulling out the fastener, so that the fastener 100 may be plugged and unplugged multiple times.

In an application of the present disclosure, the fastener 100 is used as a whole, and there is no need to separate the retaining member from the main body during use. In another application of the present disclosure, the retaining member is not detachable from the main body, for example, the retaining member may be at least partially embedded into the main body.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. Furthermore, the technical effects and/or technical problems described in this description are exemplary rather than limiting. The disclosure in this description may be used to solve other technical problems and may have other technical effects. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A fastener, comprising:
a main body comprising a supporting beam;
a retaining member being connected with the supporting beam and comprising a pair of retaining arms on a first side and a second side of the supporting beam respectively, the pair of retaining arms being configured to be deflectable toward the supporting beam to enable the retaining member to be inserted into a hole of a mounting part, and the pair of retaining arms being configured to abut against the hole to retain the fastener in the hole;
wherein the main body is made of a first material, and the retaining member is made of a second material that is more wear-resistant than the first material.

2. The fastener of claim 1, wherein:
the first material is a thermoplastic material, and the second material is a metal material.

3. The fastener of claim 2, wherein:
the retaining member is detachably mounted on the main body.

4. The fastener of claim 1, wherein:
each of the pair of retaining arms comprises an upper portion and a lower portion connected to each other, lower portions of the pair of retaining arms being connected to each other and extending along a direction away from each other, and upper portions of the pair of retaining arms extending along a direction toward each other;
wherein outer surfaces of the upper portions form contact portions abutting against the hole.

5. The fastener of claim 3, wherein:
the retaining member comprises at least one pair of deflectable connecting legs, the at least one pair of the connecting legs being provided between the pair of retaining arms and connected to the pair of retaining arms respectively, the at least one pair of connecting legs extending at an angle relative to the supporting beam and configured to resiliently clamp the supporting beam therebetween to connect the retaining member with the supporting beam.

6. The fastener of claim 5, wherein:
the supporting beam comprises a pair of ribs, the at least one pair of the deflectable connecting legs cooperating with the pair of ribs to at least prevent movement of the retaining member with respect to the supporting beam in a direction from an upper portion to the lower portion of each of the pair of the retaining arms.

7. The fastener of claim 5, wherein:
the at least one pair of deflectable connecting legs comprises a pair of first connecting legs and a pair of second connecting legs;
wherein the pair of first connecting legs are connected to upper ends of the pair of retaining arms, respectively, and extend obliquely toward each other along a direction toward lower ends of the pair of the retaining arms;
wherein the pair of second connecting legs are connected to the lower ends of the pair of retaining arms, respectively, and extend obliquely toward each other in a direction toward the upper ends of the pair of the retaining arms; and
wherein the pair of first connecting legs comprise abutting portions capable of contacting the supporting beam, the pair of second connecting legs comprise abutting portions capable of contacting the supporting beam, and the abutting portions of the pair of second connecting legs are spaced apart from the abutting portions of the pair of first connecting legs.

8. The fastener of claim 3, wherein:
the supporting beam has a third side and a fourth side opposite to the third side, the third side and the fourth side being on the two ends of the first side and the second side, respectively, and having flanges extending beyond outer surfaces of the first side and the second side, the flanges are configured to limit the retaining member therebetween.

9. The fastener of claim 3, wherein:
the main body further comprises a base, the base including a head, a neck and a body the neck being provided between the head and the body, the size of the neck being smaller than the size of the head and the size of the body, and the neck being movable into a groove of a component to be connected.

10. The fastener of claim 9, wherein:
the neck is provided with an outer profile having an anti-rotation shape, such that when the neck enters into the groove of the component to be connected, the neck prevents the rotation of the fastener with respect to the component to be connected.

11. The fastener of claim 10, wherein:
an outer contour of the neck is of a long circle shape.

12. The fastener of claim 1, characterized in that:
the fastener is configured to be mounted on the mounting part with a square hole.
